(19) United States
(12) Patent Application Publication
(10) Pub. No.: US 2005/0273322 A1
(43) Pub. Date: Dec. 8, 2005

(54) Audio signal encoding and decoding apparatus

(76) Inventors: Hyuck-Jae Lee, Seoul (KR); Sung-wook Park, Seoul (KR); Hae-kwang Park, Seoul (KR)

Correspondence Address: STANZIONE & KIM, LLP, 919 18TH STREET, N.W., SUITE 440, WASHINGTON, DC, 20006, US

(21) Appl. No.: 11/129,346

(22) Filed: May 16, 2005

Related U.S. Application Data
(60) Provisional application No. 60/576,619, filed on Jun. 4, 2004.
(60) Provisional application No. 60/578,861, filed on Jun. 14, 2004.

(30) Foreign Application Priority Data
Jun. 11, 2004 (KR) 2004-43076

(51) Int. Cl. G10L 19/00

(52) U.S. Cl. 704/212

(57) ABSTRACT

An audio signal encoding and decoding apparatus capable of transmitting an audio signal or an audio signal together with a sound-field-effect-processed audio signal are provided. The audio signal encoding apparatus includes a core encoder to encode an input audio signal according to an audio signal encoding standard, a core decoder to decode the encoded audio signal output from the core encoder, a sound-field-effect processor to perform a sound-field-effect process on the input audio signal, a selector to selectively output the input audio signal or the sound-field-effect-processed audio signal output from the sound-field-effect processor, a subtraction unit to calculate a difference signal between the signals output from the core decoder and the selector, an extension encoder to encode the difference signal output from the subtraction unit according to an arbitrary encoding scheme and to output the extension encoded signal, and a multiplexer to multiplex the encoded audio signal output from the core encoder and the extension encoded signal output from the extension encoder into a composite encoded signal and to output the composite encoded signal.

### CROSS-REFERENCE TO RELATED APPLICATIONS

This application claims the priority under 35 U.S.C. § 119 of U.S. Provisional Patent Application No. 60/576,619, filed on Jun. 4, 2004, and U.S. Provisional Patent Application No. 60/578,861, filed on Jun. 14, 2004, in the U.S. Patent and Trademark Office, and Korean Patent Application No. 2004-43076, filed on Jun. 11, 2004, in the Korean Intellectual Property Office, the disclosures of which are incorporated herein in their entirety by reference.

### BACKGROUND OF THE INVENTION

1. Field of the Invention

The present general inventive concept relates to an audio signal encoding apparatus, and more particularly, to an audio signal encoding and decoding apparatus capable of transmitting an audio signal or an audio signal together with a sound-field-effect-processed audio signal.

2. Description of the Related Art

Recently, various types of audio signal encoding schemes have been proposed. For example, the Dolby AC3 audio encoding standard is used for stereo and 5.1-channel audio sound tracks. The MPEG1 and MPEG2 audio encoding standards are used for stereo and multi-channel audio sound tracks. The Digital Theater System's (DTS) coherent acoustic audio encoding standard is used for 5.1-channel audio sound tracks processed in a studio environment.

However, these standards have problems in that their encoding processes result in loss of audio signal. In the case of a video signal, it is possible to compensate for loss of the video signal by using time correlation of the video signal. However, since the audio signal has no time correlation, it is impossible to compensate for the loss of audio signal.

In order to obtain an encoded high resolution audio signal, a method of increasing the number of sampling bits of the audio signal has been proposed. However, this method has a serious problem in that the encoding process results in increase in bit rate.

In order to cope with these problems, an audio signal encoding apparatus has been proposed. The proposed audio signal encoding apparatus has an extension encoder using a standard audio signal encoding method to preserve compatibility with existing audio signal encoding standards while transmitting lost portions of an audio signal.

The extension encoder encodes a difference signal between the audio signal and an encoded audio signal encoded by the standard audio signal encoder. Since it encodes the difference signal between the audio signal and the encoded audio signal, the proposed audio signal encoding apparatus can implement a sufficiently high resolution audio signal encoding process with a small number of bits.

FIG. 1 is a block diagram showing a conventional audio signal encoding apparatus. The conventional audio signal encoding apparatus is disclosed in U.S. Pat. No. 6,226,616. The audio signal encoding apparatus of FIG. 1 includes a core encoder 102 encoding an audio signal according to an audio signal encoding standard, a core decoder 104 decoding an encoded audio signal output from the core encoder 102, a subtraction unit 108 calculating a difference signal between the output of the core decoder 104 and the audio signal input to the core encoder 102, an extension encoder 110 encoding the difference signal output from the subtraction unit 108 according to an arbitrary encoding scheme and outputting the extension encoded signal, and a multiplexer (packer) 112 multiplexing the encoded audio signal output from the core encoder 102 and the extension encoded signal output from the extension encoder 110 and outputting a composite encoded signal. In addition, a delay unit 106 is provided to compensate for time delay of the core encoder 102 and the core decoder 104.

In the audio signal encoding apparatus of FIG. 1, the difference signal calculated between the output of the core decoder 104 and the audio signal input to the core encoder 102 is further encoded by the extension encoder 110 to obtain the extension encoded signal, and the encoded audio signal and the extension encoded signal are multiplexed and transmitted, so that an encoded high resolution audio signal can be obtained. The resolution of the audio signal output from the core decoder 104 is lower than that of the audio signal input to the core encoder 102. In addition, since the intensity of the difference signal is very small, the bit amount of the extension encoded signal output from the extension encoder 110 is also very small. Therefore, the audio signal encoding apparatus of FIG. 1 can implement a high resolution audio signal encoding process with a bit rate which is not relatively higher than the standard core encoder 102.

FIG. 2 is a block diagram showing a conventional decoding apparatus corresponding to the audio signal encoding apparatus of FIG. 1. The decoding apparatus includes a de-multiplexer (unpacker) 202 receiving the composite encoded signal transmitted from the encoding apparatus of FIG. 1 and de-multiplexing the encoded audio signal and the extension encoded signal from the composite encoded signal, and a core decoder 204 receiving and decoding the encoded audio signal output from the de-multiplexer 202 and outputting an audio signal. The audio signal output from the core decoder 204 is basically the same as the signal output from the core decoder 104 of the encoding apparatus of FIG. 1.

The decoding apparatus further comprises an extension decoder 206 receiving and decoding the extension encoded signal output from the de-multiplexer 202 and outputting a difference signal. The difference signal output from the extension decoder 206 is the same as the difference signal output from the subtraction unit 108 of the encoding apparatus of FIG. 1.

The decoding apparatus further comprises an addition unit 208 which adds the encoded audio signal output from the core encoder 204 and the difference signal output from the extension decoder 206. By using the addition unit 208, the audio signal input to the core encoder 102 of the encoding apparatus of FIG. 1 is reproduced.

Various technologies for performing a sound-field-effect process on an audio signal have also been proposed. One example of the sound-field-effect-processed signals is a binaural signal. The binaural signal is obtained by recording sounds at the positions corresponding to two human ears. Since it is similar to the really-heard acoustic signal, the binaural signal provides high sound quality and sound-field feeling. In addition, the binaural signal is suitable for a headphone.

Another example of a technology for performing a sound-field-effect process is a collective sound-field waveform reproduction technology. According to this technology, the audio signal is differentiated, and the differentiated signals are incorporated into a large signal. By transmitting the large signal, it is possible to output a high resolution audio signal.

Another example of a technology for performing a sound field-effect process is music hall simulation technology. In this technology, famous music halls in the world are simulated to implement optimal audio signals.

In conventional audio signal encoding technologies, transmission of the sound-field-effect-processed signal together with the audio signal has not been taken into consideration. This is because the sound-field-effect has been only treated as a problem on user's selection and the audio signal encoding process has been related to only the audio signal.

However, in transmission of an encoded audio signal, the encoded audio signal added with a sound-field effect is greatly advantageous to the user. For example, if the binaural signal can be output through a headphone of an audio system, the user does not need to prepare a high price device such as a binaural recorder.

Therefore, an improved approach to transmit a sound-field-effect-processed signal while preserving compatibility with an audio signal encoding standard is needed.

### SUMMARY OF THE INVENTION

The present general inventive concept provides an audio signal encoding apparatus capable of transmitting an audio signal or an audio signal together with a sound-field-effect-processed audio signal.

The present general inventive concept provides a decoding apparatus corresponding to the audio signal encoding apparatus.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an audio signal encoding apparatus capable of transmitting an audio signal or an audio signal together with a sound-field-effect-processed audio signal.

The audio signal encoding apparatus includes a core encoder to encode an input audio signal according to an audio signal encoding standard, a core decoder to decode the encoded audio signal output from the core encoder, a sound-field-effect processor to perform a sound-field-effect process on the input audio signal, a selector to selectively output one of the input audio signal and the sound-field-effect-processed audio signal output from the sound-field-effect processor, a subtraction unit to calculate a difference signal between the signals output from the core decoder and the selector, an extension encoder to encode the difference signal output from the subtraction unit according to an arbitrary encoding scheme and to output a resultant extension encoded signal, and a multiplexer to multiplex the encoded audio signal output from the core encoder and the extension encoded signal output from the extension encoder into a composite encoded signal and to output the composite encoded signal.

The foregoing and/or other aspects of the present general inventive concept are also achieved by providing an audio signal decoding apparatus capable of transmitting an audio signal or an audio signal together with a sound-field-effect-processed audio signal.

The audio signal decoding apparatus includes a de-multiplexer to receive, de-multiplex, and output an encoded audio signal and an extension encoded signal, a core decoder to decode the encoded audio signal output from the de-multiplexer and to output the decoded audio signal, an extension decoder to decode the extension encoded signal output from the de-multiplexer and to output a resultant difference signal, and an addition unit to add the decoded audio signal output from the core decoder and the difference signal output from the extension decoder, wherein the extension encoded signal includes a sound-field-effect processed signal.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram showing a conventional audio signal encoding apparatus;

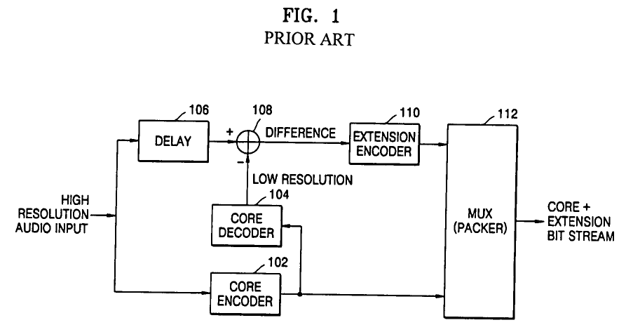

FIG. 2 is a block diagram showing a conventional decoding apparatus corresponding to the audio signal encoding apparatus shown in FIG. 1;

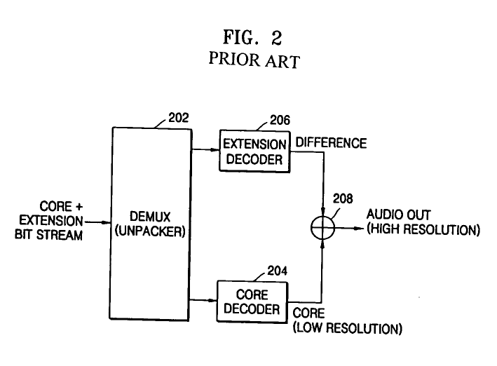

FIG. 3 is a block diagram illustrating an audio signal encoding apparatus according to an embodiment of the present general inventive concept;

FIG. 4 is a block diagram illustrating a decoding apparatus according to an embodiment of the present general inventive concept corresponding to the audio signal encoding apparatus of FIG. 3;

FIG. 5 is a diagram illustrating an audio signal encoding and decoding apparatus according to an embodiment of the present general inventive concept;

FIG. 6 is a diagram illustrating an audio signal encoding and decoding apparatus according to another embodiment of the present general inventive concept;

FIG. 7 is a schematic view illustrating operations of a down mixer of the audio signal encoding and decoding apparatus of FIG. 6; and

FIG. 8 is a diagram illustrating an audio signal encoding and decoding apparatus according to still another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

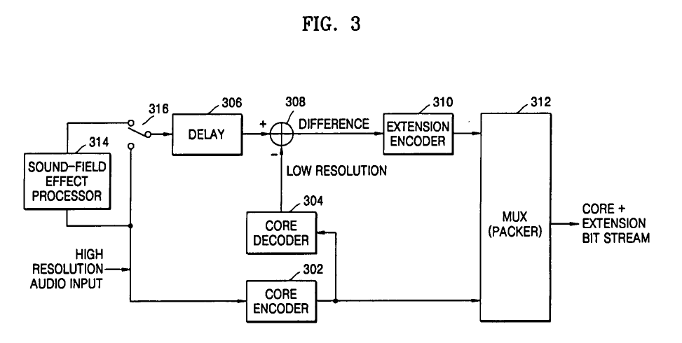

FIG. 3 is a block diagram illustrating an audio signal encoding apparatus according to an embodiment of the present general inventive concept. The audio signal encoding apparatus includes a core encoder 302 to encode an input audio signal according to an audio signal encoding standard, a core decoder 304 to decode the encoded audio signal output from the core encoder 302, a sound-field-effect processor 314 to perform a sound-field-effect process on the input audio signal, a selector 316 to selectively output one of the input audio signal and the sound-field-effect-processed audio signal output from the sound-field-effect processor 314, a subtraction unit 308 to calculate a difference signal between the one of the input audio signal and the sound-field effect processed audio signal output from the selector 316 and the decoded audio signal output from the core decoder 304, an extension encoder 310 to encode the difference signal output from the subtraction unit 308 according to a predetermined encoding scheme and to output a resultant extension encoded signal, and a multiplexer (packer) 312 to multiplex the encoded audio signal output from the core encoder 302 and the extension encoded signal output from the extension encoder 310 to generate a composite encoded signal and to output the composite encoded signal. In addition, a delay unit 306 can be provided between the selector 316 and the subtraction unit 308 to compensate for processing times of the core encoder 302 and the core decoder 304.

In the encoding apparatus of FIG. 3, in a case in which the selector 316 selects and outputs the input audio signal, the difference signal between the input audio signal and the decoded audio signal output from the core decoder 304 is obtained from the subtraction unit 308. Accordingly, the multiplexer 312 outputs the composite encoded signal including the encoded audio signal and the extension encoded signal obtained by encoding the difference signal between the input audio signal and the decoded audio signal output from the core decoder 304.

On the other hand, in the encoding apparatus of FIG. 3, in a case in which the selector 316 selects the sound-field-effect-processed audio signal output from the sound-field-effect processor 314, the encoded audio signal output from the core encoder 302 can be transmitted from the encoding apparatus together with the sound-field-effect-processed audio signal. More specifically, in this case, the difference signal between the sound-field-effect-processed audio signal and the decoded audio signal output from the core decoder 304 is obtained from the subtraction unit 308. Accordingly, the multiplexer 312 outputs the composite encoded signal including the encoded audio signal and the extension encoded signal obtained by encoding the difference signal between the sound-field-effect-processed audio signal and the decoded audio signal output from the core decoder 304.

In an example in which the sound-field-effect processor 314 is a binaural recorder, the extension encoder 310 outputs the extension encoded signal obtained by encoding the difference signal between a binaural signal output from the binaural recorder and the decoded audio signal output from the core decoder 304. The multiplexer 312 then outputs the composite encoded signal including the encoded audio signal and the extension encoded signal. In an audio device receiving the composite encoded signal encoded by the encoding apparatus of FIG. 3, the input audio signal can be output from a speaker and the binaural signal can be output from a headphone output port.

The core encoder 302 can be an audio signal encoding apparatus, such as for example, a Dolby AC3 encoder, an MEPG audio encoder, and a DTS encoder.

A resolution of the encoded audio signal output from the core decoder 304 is lower than that of the input audio signal input to the core encoder 302. In addition, since an intensity of the difference signal output from the subtraction unit 308 is small, a bit amount of the extension encoded signal output from the extension encoder 310 is also small. Therefore, the audio signal encoding apparatus as illustrated in FIG. 3 can implement a high or a low resolution audio signal encoding process and a sound-field-effect process with a bit rate which is not relatively higher than that of the core encoder 302.

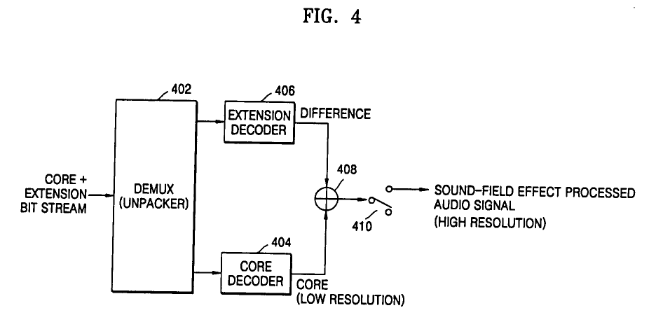

FIG. 4 is a block diagram illustrating a decoding apparatus according to an embodiment of the present general inventive concept corresponding to the audio signal encoding apparatus of FIG. 3. The decoding apparatus includes a de-multiplexer (unpacker) 402 to receive the composite encoded signal transmitted from the encoding apparatus of FIG. 3 and to de-multiplex the encoded audio signal and the extension encoded signal from the composite encoded signal, and a core decoder 404 to receive and decode the encoded audio signal output from the de-multiplexer 402 and to output the decoded audio signal. In addition, the decoding apparatus further comprises an extension decoder 406 to receive and decode the extension encoded signal output from the de-multiplexer 402 and to output the decoded extension signal (i.e. the difference signal).

The decoding apparatus further comprises an addition unit 408 to add the decoded audio signal output from the core decoder 404 and the decoded extension signal output from the extension decoder 406. By using the addition unit 408, one of the input audio signal of the encoding apparatus of FIG. 3 and the sound-field-processed audio signal output from the sound-field effect processor 314 of the encoding apparatus is reproduced.

A selector 410 selectively outputs the signal output from the addition unit 408 to one of plural output ports. In the case in which the encoded audio signal and the extension encoded signal obtained by encoding the difference signal between the input audio signal and the decoded audio signal are transmitted from the encoding apparatus as the composite encoded signal, the input audio signal is reproduced by the decoding apparatus and output to a first output port by the selector 410.

On the other hand, in the case in which the encoded audio signal and the extension encoded signal obtained by encoding the difference signal between the sound-field-effect-processed audio signal and the decoded audio signal are transmitted from the encoding apparatus of FIG. 3 as the composite encoded signal, the sound-field-effect-processed audio signal is reproduced by the decoding apparatus and output to a second output port by the selector 410. When the sound-field-effect-processed audio signal is output to the second output port by the selector 410, the decoded audio signal can be output to the first output port from the core decoder 404. The first and second output ports may be, for example, speakers and a headphone, respectively.

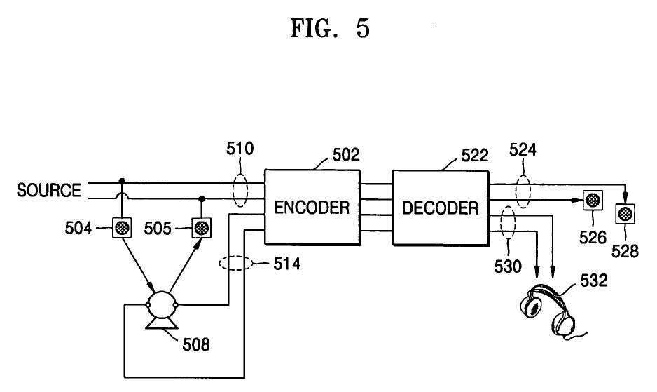

FIG. 5 illustrates an audio signal encoding and decoding apparatus according to an embodiment of the present general inventive concept. More specifically, as illustrated in FIG. 5, a 2-channel stereo signal 510 and a binaural signal 514 are encoded and decoded.

Referring to FIG. 5, an encoder 502 is similar to the encoding apparatus as illustrated in FIG. 3 except for the sound-field-effect processor 314. The encoder 502 can perform an encoding process on the stereo signal 510. In this case, a core encoder and a core decoder of the encoder 502 perform encoding and decoding processes, respectively.

Speakers 504 and 505 and a binaural recorder 508 perform operations similar to the sound-field-effect processor 314 of the encoding apparatus of FIG. 3. The speakers 504 and 505 output the stereo signal 510. The binaural recorder 508 records the stereo signal 510 output from the speakers 504 and 505 as human-audible signals (i.e. the binaural signal) 514. More specifically, the binaural recorder 508 records the human-audible signals 514 by using two acoustic receivers located at positions corresponding to two human ears.

In a case in which a selector of the encoder 502 selects the stereo signal 510 input to the encoder 502, the encoder 502 performs an encoding process on the stereo signal 510. That is, the core encoder of the encoder 502 encodes the stereo signal 510 and the core decoder of the encoder 502 decodes the encoded stereo signal. A subtraction unit of the encoder 502 calculates a difference signal between the input stereo signal 510 and the decoded stereo signal. An extension encoder of the encoder 502 encodes the calculated difference signal, and a multiplexer of the encoder 502 multiplexes the encoded difference signal and the encoded stereo signal and outputs a resultant composite encoded signal.

On the other hand, in a case in which the selector of the encoder 502 selects the binaural signal 514 output from the binaural recorder 508, the encoder 502 performs an encoding process on the stereo signal 510 and the binaural signal 514. That is, the core encoder of the encoder 502 encodes the stereo signal 510 and the core decoder of the encoder 502 decodes the encoded stereo signal. The subtraction unit of the encoder 502 calculates a difference signal between the binaural signal 514 and the decoded stereo signal. The extension encoder of the encoder 502 encodes the calculated difference signal, and the multiplexer of the encoder 502 multiplexes the encoded difference signal and the encoded stereo signal and outputs a resultant composite encoded signal.

In the encoding and decoding apparatus of FIG. 5, a decoder 522 is similar to the decoding apparatus as illustrated in FIG. 4. The decoder 522 decodes the composite encoded signal and outputs a decoded stereo signal 524 or a decoded binaural signal 530 or the decoded stereo signal 524 together with the decoded binaural signal 530.

The decoded stereo signal 524 is output through speakers 526 and 528. The decoded binaural signal 530 is output through a headphone 532. The speakers 526 and 528 output a high or a low resolution stereo signal 524 according to the encoding operations of the encoder 502.

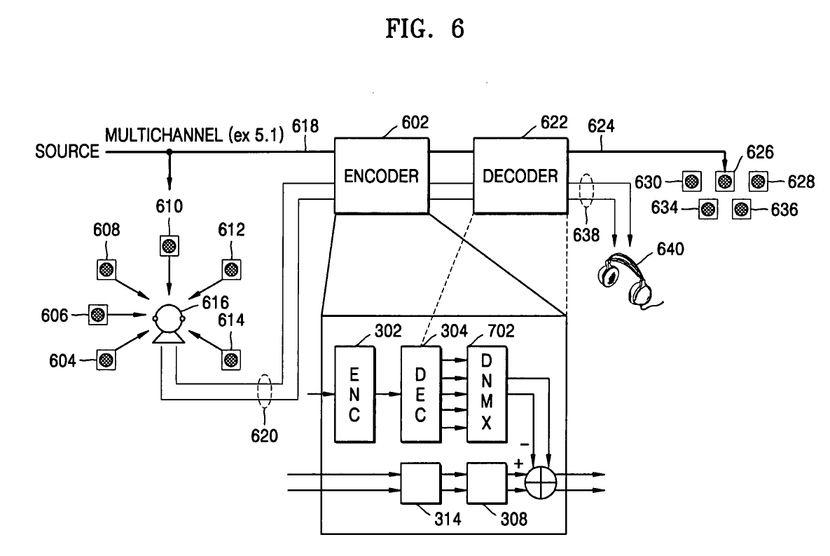

FIG. 6 illustrates an audio signal encoding and decoding apparatus according to another embodiment of the present general inventive concept. More specifically, as illustrated in FIG. 6, a 5.1-channel signal 618 and a binaural signal 620 are encoded and decoded.

Referring to FIG. 6, an encoder 602 is similar to the encoding apparatus as illustrated in FIG. 3 except for the sound-field-effect processor 314. Speakers 604, 606, 608, 610, 612, and 614 and a binaural recorder 616 perform operations similar to the sound-field-effect processor 314 of the encoding apparatus of FIG. 3. The encoder 602 performs an encoding process on the 5.1-channel signal 618 or the 5.1 channel signal 618 together with the binaural signal 620.

In a case in which a selector (similar to 316 of FIG. 3) of the encoder 602 selects the 5.1-channel signal 618 input to the encoder 602, the encoder 602 performs an encoding process on the 5.1-channel signal 618. That is, a core encoder 302 of the encoder 602 encodes the 5.1-channel signal 618 and a core decoder 304 of the encoder 602 decodes the encoded 5.1-channel signal. A subtraction unit 308 of the encoder 602 calculates a difference signal between the input 5.1-channel signal 618 and the decoded 5.1-channel signal. An extension encoder (not shown) of the encoder 602 encodes the calculated difference signal, and a multiplexer (not shown) of the encoder 602 multiplexes the encoded difference signal and the encoded 5.1-channel signal and outputs a resultant composite encoded signal.

On the other hand, in a case in which the selector selects the binaural signal 620 output from the binaural recorder 616, the encoder 602 performs an encoding process on the 5.1-channel signal 618 and the binaural signal 620. That is, the core encoder 302 of the encoder 602 encodes the 5.1-channel signal 618, and the core decoder 304 of the encoder 602 decodes the encoded 5.1-channel signal. The subtraction unit 308 of the encoder 602 calculates a difference signal between the binaural signal 620 and the decoded 5.1-channel signal. The extension encoder of the encoder 602 encodes the calculated difference signal, and the multiplexer of the encoder 602 multiplexes the encoded difference signal and the encoded 5.1-channel signal and outputs a resultant composite encoded signal.

In the audio signal encoding and decoding apparatus of FIG. 6, a decoder 622 is similar to the decoding apparatus as illustrated in FIG. 4. The decoder 622 outputs a decoded 5.1-channel signal 624 or a decoded binaural signal 638 or the decoded 5.1-channel signal 624 together with the decoded binaural signal 638.

As illustrated in FIG. 6, the decoded 5.1-channel signal 624 is output though speakers 626, 628, 630, 634, and 636. The decoded binaural signal 638 is output through a headphone 640. The speakers 626 to 636 output a high or a low resolution 5.1-channel signal 624 according to the encoding operations of the encoder 602.

In order to match up the 5.1-channel signal 618 with the 2-channel binaural signal 620, the encoder 602 includes a down mixer 702 to convert the decoded 5.1-channel signal output from the core decoder 304 into a 2-channel signal.

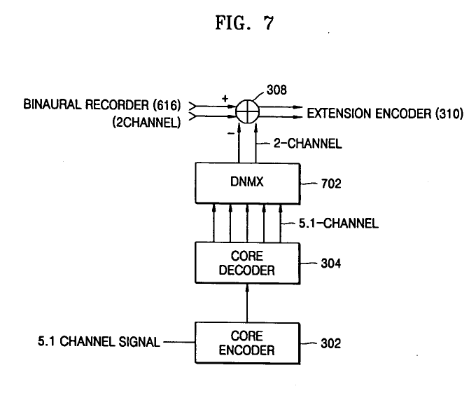

FIG. 7 is a schematic view illustrating operations of the down mixer 702 of the encoder 602 of the apparatus of FIG. 6. The decoded 5.1-channel signal output from the core decoder 304 is input to the down mixer 702. The down mixer 702 performs a down mixing process on the 5.1-channel signal to obtain the 2-channel signal. The 2-channel signal output from the down mixer 702 and the 2-channel signal (i.e. the binaural signal) 620 output from the binaural recorder 616 are input to the subtraction unit 308. The subtraction unit then calculates the difference signal and outputs the difference signal to the extension encoder 310.

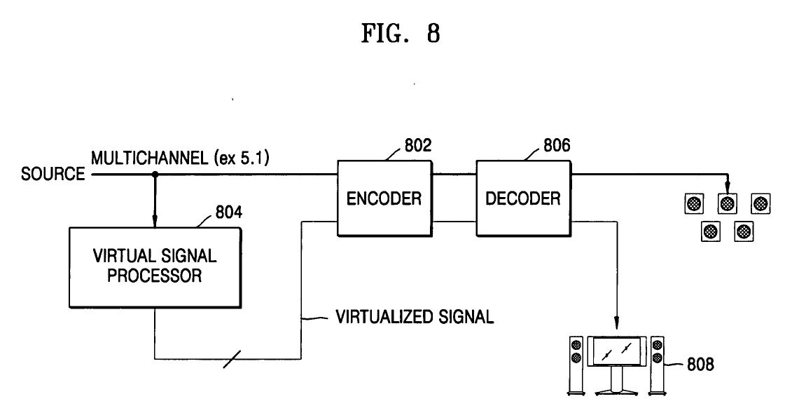

FIG. 8 illustrates an audio signal encoding and decoding apparatus according to still another embodiment of the present general inventive concept. More specifically, as illustrated in FIG. 8, a multi-channel signal and a virtual signal are encoded and decoded. A virtual signal processor 804 processes the multi-channel signal to generate the virtual signal. The virtual signal may be a signal processed in a studio environment or generated with a music hall simulation technology.

Referring to FIG. 8, an encoder 802 is similar to the encoding apparatus as illustrated in FIG. 3. The encoder 802 performs an encoding process on the multi-channel signal. In addition, the encoder 802 performs an encoding process on the multi-channel signal and the virtual signal.

In the apparatus of FIG. 8, a decoder 806 is similar to the decoding apparatus as illustrated in FIG. 4. The decoder 806 outputs a decoded multi-channel signal or the decoded multi-channel signal together with a decoded virtual signal.

The decoded multi-channel signal is output through speakers. The decoded virtual signal is output through an audio processing system 808 corresponding to a virtual signal processing system. The speakers output a high or a low resolution multi-channel signal according to the encoding operations of the encoder 802.

As described above, in an audio signal encoding apparatus according to various embodiments of the present general inventive concept, since an audio signal is encoded or since an audio signal and a sound-field-effect-processed audio signal are encoded, it is possible to meet various demands of users.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An audio signal encoding apparatus comprising:
a core encoder to encode an input audio signal according to an audio signal encoding standard;
a core decoder to decode the encoded audio signal output from the core encoder;
a sound-field-effect processor to perform a sound-field-effect process on the input audio signal;
a selector to selectively output the audio signal input to the core encoder or the sound-field-effect-processed audio signal output from the sound-field-effect processor;
a subtraction unit to calculate a difference signal between the signals output from the core decoder and the selector;
an extension encoder to encode the difference signal output from the subtraction unit according to a predetermined encoding scheme and to output the extension encoded signal; and
a multiplexer to multiplex the encoded audio signal output from the core encoder and the extension encoded signal output from the extension encoder into a composite encoded signal and to output the composite encoded signal.

2. The audio signal encoding apparatus according to claim 1, wherein the sound-field-effect processor comprises a binaural recorder.

3. The audio signal encoding apparatus according to claim 2, further comprising:
a down mixer to perform a down mixing process on a 5.1-channel audio signal output from the core decoder into a 2-channel signal according to a 2-channel binaural signal.

4. An audio signal decoding apparatus, comprising:
a de-multiplexer to receive, de-multiplex and output an encoded audio signal and an extension encoded signal;
a core decoder to decode the encoded audio signal output from the de-multiplexer and to output the decoded audio signal;
an extension decoder to decode the extension encoded signal output from the de-multiplexer and to output a resultant difference signal; and
an addition unit to add the decoded audio signal output from the core decoder and the difference signal output from the extension decoder,
wherein the extension encoded signal includes a sound-field-effect processed signal.

5. The audio signal decoding apparatus according to claim 4, further comprises a selector to selectively output the signal output from the addition unit to plural output ports.

6. An audio signal encoding apparatus comprising:
a core encoder to encode an input audio signal according to an audio signal encoding standard;
a core decoder to decode the encoded audio signal output from the core encoder;
a selector to selectively output the audio signal input to the core encoder or an audio signal obtained by performing a sound-field-effect process on the input audio signal;
a subtraction unit to calculate a difference signal between the signals output from the core decoder and the selector;
an extension encoder to encode the difference signal output from the subtraction unit according to an arbitrary encoding scheme and to output the extension encoded signal; and
a multiplexer to multiplex the encoded audio signal output from the core encoder and the extension encoded signal output from the extension encoder into a composite encoded signal and to output the composite encoded signal.

7. An encoding apparatus, comprising:
a core encoder to encode an input audio signal;
a field-effect processing unit to perform a field effect process on the input audio signal;
a core decoder to decode the encoded audio signal;
a calculation unit to calculate a difference signal between the field-effect process audio signal and the decoded audio signal;
an extension encoder to encode the difference signal; and
a multiplexer to multiplex and output the encoded audio signal and the encoded difference signal.

8. The encoding apparatus according to claim 7, wherein the input audio signal comprises one of a 2 channel stereo signal and a 5.1 channel signal.

9. The encoding apparatus according to claim 7, wherein the field effect processing unit comprises one of a binaural recorder and a virtual signal processing unit.

10. The encoding apparatus according to claim 7, further comprising:
a switch to bypass the field effect processing unit such that the calculation unit calculates the difference signal between the input audio signal and the decoded audio signal when the switch bypasses the field effect processing unit.

11. The encoding apparatus according to claim 7, further comprising:
a down mixer to down mix the decoded audio signal to be compatible with the field-effect processed audio signal and to output the down mixed signal to the calculation unit.

12. The encoding apparatus according to claim 7, further comprising:
a delay unit provided between the field-effect processing unit and the calculation unit to compensate for processing times of the core encoder and core decoder.

13. An encoding and decoding apparatus comprising:
a field effect processing unit to process an input audio signal according to a predetermined field-effect;
an encoding unit to encode the input audio signal and portions of the field-effect processed audio signal different from the input audio signal and to output a composite signal including the encoded input audio signal and the encoded portions of the field-effect processed signal; and
a decoding unit to decode the encoded input audio signal and the encoded portions of the field-effect processed signal.

14. The encoding and decoding apparatus according to claim 13, further comprising:
speakers connected to the decoding unit to output the decoded input audio signal; and
headphones connected to the decoding unit to output the decoded field effect processed signal.

15. The encoding and decoding apparatus according to claim 13, wherein the field effect processing unit comprises:
speakers to output sound according to the input audio signal; and
a binaural recorder to record a binaural signal according to the sound output by the speakers.

16. The encoding and decoding apparatus according to claim 13, wherein the field effect processing unit comprises:
a virtual signal processor to process the input audio signal to generate a virtual signal.

17. The encoding and decoding apparatus according to claim 13, wherein the encoding unit comprises:
a core encoder to encode the input audio signal;
a calculation unit to decode the encoded input audio signal and to calculate a difference signal between the field-effect processed audio signal and the decoded input audio signal;
an extension encoder to encode the calculated difference signal; and
a multiplexer to multiplex the encoded input audio signal and the encoded difference signal to generate the composite signal.

18. The encoding and decoding apparatus according to claim 17, wherein the decoding unit comprises:
a demultiplexer to demultiplex the composite signal and to output the encoded input audio signal and the encoded difference signal;
a core decoder to decode the encoded input audio signal;
an extension decoder to decode the encoded difference signal; and
an adder to add the decoded difference signal and the decoded input audio signal.

19. The encoding and decoding apparatus according to claim 13, wherein the decoding unit comprises:
first and second output ports; and
a selector to output the decoded input audio signal to the first output port and to output the decoded field-effect signal to the second output port.

20. An encoding and decoding apparatus comprising:
an encoding unit to encode an input audio signal and a difference signal including portions of an input field-effect audio signal and to output a composite signal including the encoded input audio signal and the encoded difference signal; and
a decoding unit to decode the encoded input audio signal and the encoded difference signal and to combine the decoded input audio signal and the decoded difference signal to reproduce the input audio signal and the input field-effect processed audio signal.

21. A method of encoding an audio signal together with an field-effect processed signal, the method comprising:
encoding an input audio signal;
decoding the encoded audio signal;
processing the input audio signal according to a predetermined field-effect;
calculating a difference signal between one of the input audio signal and the field-effect processed audio signal and the decoded audio signal;
encoding the calculated difference signal; and
multiplexing the encoded difference signal with the encoded audio signal to generate a composite encoded signal and outputting the composite encoded signal.
